(19) United States
(12) Patent Application Publication
(10) Pub. No.: US 2015/0143869 A1
(43) Pub. Date: May 28, 2015

(54) METHOD FOR INTERNAL COMBUSTION ENGINE EXHAUST FLOW MEASUREMENT CALIBRATION AND OPERATION

(71) Applicant: Sensors, Inc., Saline, MI (US)

(72) Inventor: David R. Booker, Ann Arbor, MI (US)

(21) Appl. No.: 14/548,811

(22) Filed: Nov. 20, 2014

Related U.S. Application Data
(60) Provisional application No. 61/909,699, filed on Nov. 27, 2013.

(51) Int. Cl. G01F 25/00; G01F 1/46

(52) U.S. Cl. CPC G01F 25/0007; G01F 1/46
USPC 73/1.29; 73/861.65

(57) ABSTRACT

A calibration method for a flow measuring device used with a vehicle exhaust analysis system includes the flow measuring device being connected with the vehicle exhaust system wherein exhaust gases are directed through the flow measuring device. A portable flow calibration device is connected in a manner that exhaust gases of the vehicle exhaust system are directed through the portable flow calibration device. The vehicle is operated so that exhaust gas flows through the flow measuring device and the flow calibration device. The flow measuring device is calibrated with the portable flow calibration device. The flow measuring device includes a Pitot tube assembly in a flow tube wherein gas flowing through the flow tube passes the Pitot tube assembly. The Pitot tube assembly includes a sensing tube and at least one pressure sensing port connected with the sensing tube. The sensing tube includes a plurality of sensing openings that are positioned at different portions of gas flowing through the flow tube.

### CROSS REFERENCE TO RELATED APPLICATION

This application claims priority from U.S. patent application Ser. No. 61/909,699, filed on Nov. 27, 2013, the disclosure of which is hereby incorporated herein by reference.

### BACKGROUND OF THE INVENTION

The present invention is directed to a calibration method for a flow measuring device used with a vehicle exhaust analysis system and a compact flow measuring device that may be used with the vehicle exhaust system.

Standard ICE emissions exhaust flow measurement devices must currently be calibrated away from the vehicle in a fixed laboratory installation using specialized and onerous calibration equipment against a primary standard. Measurement of emissions is typically reported as break-specific emissions. A typical unit to report emissions for regulated and non-regulated pollutants is mass per brake horsepower-hour (e.g., g/bhp-hr). This exhaust flow measurement information is also used in chemical-balance calculations to determine work from brake-specific fuel consumption and fuel consumed. Emissions are reported in g/Km in other standards.

To calculate emissions, several data inputs are required, including, but not limited to, the real-time measurement of concentrations (molar basis) of the regulated and/or non-regulated pollutants and exhaust flow measurement. Measurement of exhaust flow rate is done under flow conditioning operational restraints. While this allows measuring exhaust flow after cooling of the exhaust, the operational condition under which cooled exhaust flow measurement can be performed is restrained. Exhaust flow measurement should be preferably performed on hot exhaust.

U.S. Pat. No. 5,639,957 discloses that computed exhaust mass flow rates and thus mass emission calculations of the various regulated pollutants calculated from indirect measurements, for example, parameters recorded in the engine control module (ECM), may be in error by as much as 30-50% from the actual exhaust mass flow rate.

Technology improvements to the various on-board diagnostic (OBD) sensors have been established. Calculations utilizing these OBD sensors and the theoretical model used are still subject to errors outside the limits of accuracy required for regulatory driven portable emission measurement (PEM) system measurements. Consequently, exhaust flow meters (EFMs) that attach to the vehicle have been developed, such as in U.S. Pat. No. 5,639,957, that are calibrated to a primary flow standard meeting National traceability requirements. These EFMs, which are commercially available, such as from Sensors Inc., Saline, Mich., USA, have been designed, tested and validated to perform within the regulatory specifications on the vehicle. However, since these devices are subject to contamination and, therefore, a potential deterioration in performance, these EFMs are subject to frequent performance verifications/calibrations. In addition, to mitigate erroneous readings due to installation and vehicle specific geometries, these EFMs are constructed to have multiple pipe diameters (PDs) of straight pipe upstream and downstream of the flow measurement device. This ensures, or reduces significantly, any flow disturbances caused by, for example, bends that could impact on the accuracy of the measurement device. The consequence of such an approach is that these EFMs, which are mounted outside the vehicle, introduce aerodynamic changes to the vehicle and add additional mass to the vehicle.

Known procedures to calibrate a flow device for a PEM are shown in FIG. 1. The flow measurement device is removed from the vehicle and transported to an accredited laboratory equipped with an apparatus considered primary flow standard meeting national traceability requirements (i.e., a calibration reference quantity that is NIST traceable). Additionally, such calibration device is a fixed, large installation that occupies a wall approximately six (6) meters in length and four (4) meters in height. This task is associated with significant infrastructure, time and labor costs. The calibrated flow meter is calibrated using dry air and then brought back to the vehicle and re-installed. This task is also associated with significant time and labor costs.

### SUMMARY OF THE INVENTION

The techniques presented herein provide significant measurement quality and operational quality improvements upon existing methods and technologies while remaining within the requirements defined by regulations.

A calibration method for a flow measuring device used with a vehicle exhaust analysis system, according to an aspect of the invention, includes the flow measuring device being connected with the vehicle exhaust system wherein exhaust gases are directed through the flow measuring device. A portable flow calibration device is connected in a manner that exhaust gases of the vehicle exhaust system are directed through the portable flow calibration device. The vehicle is operated so that exhaust gas flows through the flow measuring device and the flow calibration device. The flow measuring device is calibrated with the portable flow calibration device.

A flow measuring device, according to an aspect of the invention, includes a Pitot tube assembly in a flow tube wherein gas flowing through the flow tube passes the Pitot tube assembly. The Pitot tube assembly includes a sensing tube and at least one pressure sensing port connected with the sensing tube. The sensing tube includes a plurality of sensing openings that are positioned at different portions of gas flowing through the flow tube.

A flow measuring device, such as a mini-flow meter of the type disclosed herein can be calibrated onboard a vehicle, a much simpler task, while still meeting accepted regulatory standards for the application. An improvement in the calibration performance for vehicle-specific accuracy of the flow measurement may be realized as the experimental measurement data used for the flow meter calibration now takes into consideration the flow sensing elements specific to the vehicle, such exhaust gas pressure, temperature and chemical composition. The latter also enables calculation of gas molecular weight, which is required in the flow calibration model, when the flow meter is used in conjunction with a PEMS gaseous measurement device, yielding improve vehicle-specific accuracy in exhaust flow determination.

Additionally, the use of a reduced form factor (lighter, smaller) flow meter presents further advantages when compared to existing flow meters, such as reduced aerodynamic drag, reduced weight, and ease of installation leading to enhanced operational safety. The reduced form factor flow meter can be embedded into the vehicle exhaust system, a feature useful for vehicle manufacturers as this allows semi-permanent installation with significant ease of operation. A complete analyzer, including the smaller and lighter flow meter, may be installed outside the vehicle using off-the-shelf trailer-hitch mounted carrier racks while operation on the road without violating maximum weight limits for such accessories.

The need for significant upstream and downstream pressure detectors may be eliminated by applying a vehicle specific calibration to either a secondary or primary reference flow device. In the case of a secondary calibration device, a traditional EFM could be temporarily mounted to the vehicle to calibrate flows over normal driving behavior. Alternatively, a secondary or primary calibrating device could be used in a laboratory environment (for example, a chassis dynamometer test cell) to provide the calibration flows necessary. In both cases, the exhaust flow is produced from the vehicle itself under normal or simulated driving.

The use of either a secondary or primary flow calibration standard also eliminates the need of returning the EFMs to accredited laboratories for re-calibration on a frequent basis. Normal calibration methodologies of solving the flow sensing elements relationship to the reference device can be more-easily performed meeting the requirement that the range of the reference flow rates used meets the operational device flow rates. In addition, important variables that influence the operational characteristics of the flow sensing element, such as pressure, temperature and gas molecular weight, can be measured when used in conjunction with PEMS gaseous measurement systems. For the measurement of gas molecular weight, the gaseous PEMs components are used. Alternatively, a laboratory gaseous analyzer could be used.

Calibrating the flow meter already installed on-board the vehicle exhaust system may be simplified. An operational configuration using a chassis dynamometer to produce exhaust flow from the vehicle itself under simulated driving conditions can be used. The use of exhaust flow produced from the vehicle itself under normal or simulated driving conditions avoids potential compounding measurement sources of errors caused by pressure, temperature, and gas molecular weight.

These and other objects, advantages and features of this invention will become apparent upon review of the following specification in conjunction with the drawings.

### BRIEF DESCRIPTION OF THE DRAWINGS

FIG. 1 is a process flow diagram of a procedure for flow meter calibration according to the prior art;

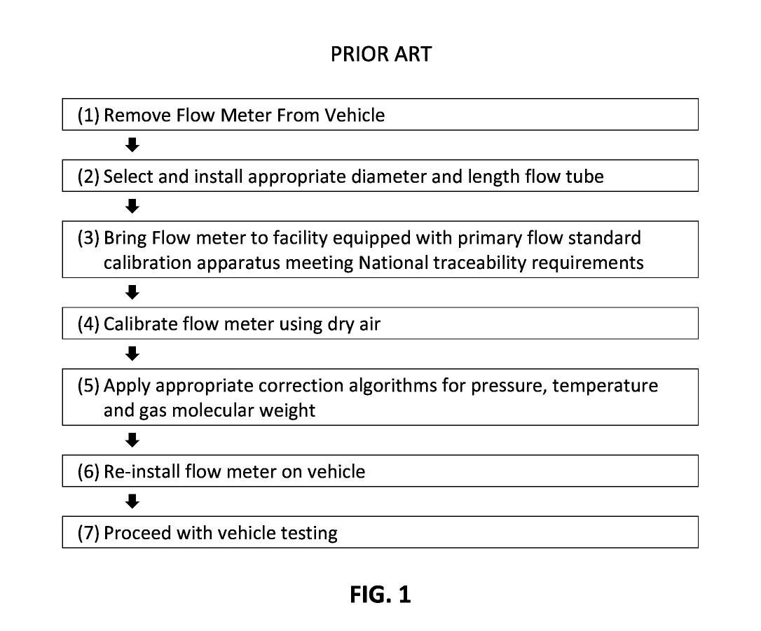

FIG. 2 is a process flow diagram of a procedure for flow meter calibration according to an aspect of the invention;

FIG. 3 is a perspective view of an averaging Pitot tube according to an aspect of the invention;

FIG. 4 is a sectional view taken along the lines IV-IV in FIG. 3;

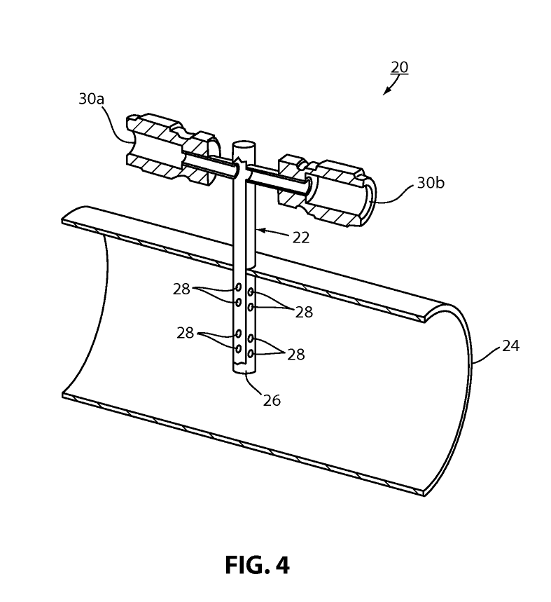

FIG. 5 is an enlargement of the view of FIG. 4 illustrating operation thereof of the averaging Pitot tube;

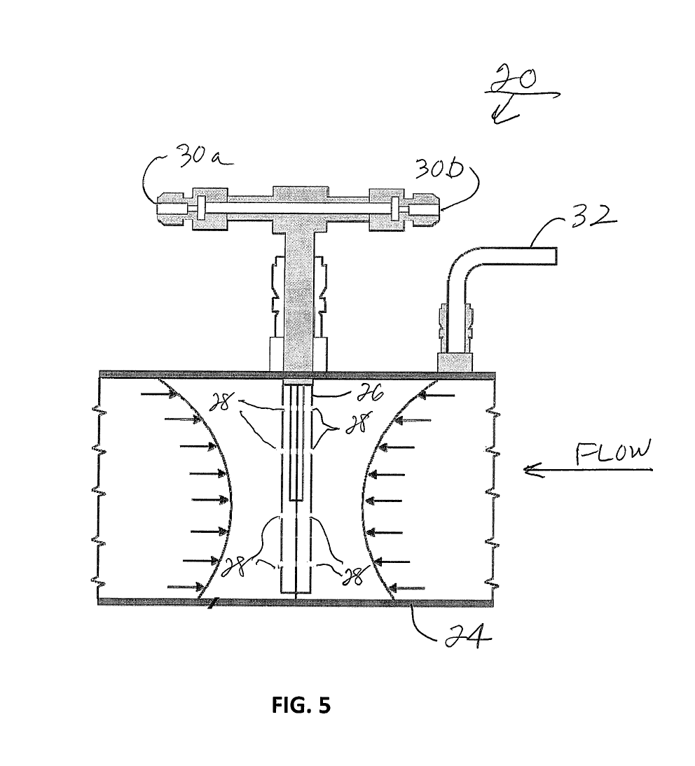

FIG. 6 is a schematic diagram of a test setup using a chassis dynamometer to produce exhaust flow from the vehicle under simulated driving conditions;

FIG. 7 is a perspective view of the flow sensing element used in the test setup in FIG. 6;

FIG. 8 shows the flow sensing element in FIG. 7 connected with a PEMS;

FIG. 9 is the same view as FIG. 7 of an alternative embodiment thereof; and

FIG. 10 is a rear elevation view of a vehicle showing a complete analyzer solution mounted to the vehicle.

### DESCRIPTION OF THE PREFERRED EMBODIMENT

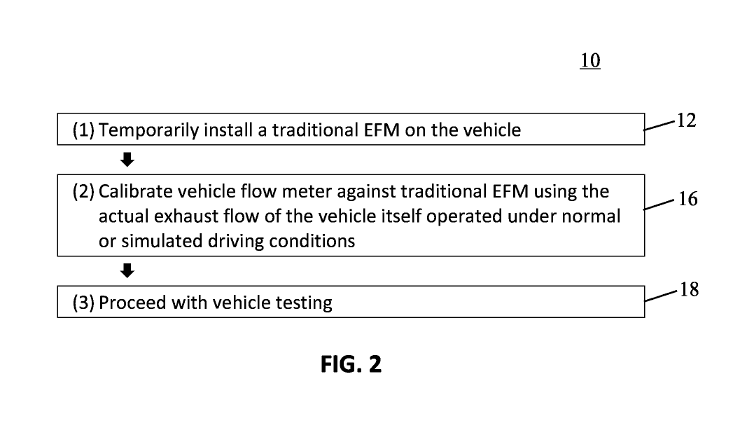

Referring now to the drawings and the illustrative embodiments depicted therein, A flow meter calibration process 10 begins by temporarily installing a reference portable flow calibration meter (EFM) on the vehicle at 12 (FIG. 2). The EFM meets regulatory requirements of traceability. The EFM is used to measure exhaust flow on the vehicle. A test vehicle flow meter is mounted to the vehicle exhaust system at 16. The vehicle is then operated under normal or simulated driving conditions at 18. When operated on the vehicle, the exhaust gas has a chemical composition that is different from the dry air used during a traditional calibration process. In particular, the exhaust gas contains H₂O, CO, CO₂, XOx, HC's, PM, and the like. Gas molecular weight correction algorithms are applied in order to compensate for various sources of measurement error. The test vehicle flow meter can also be transferred from one vehicle to a vehicle using a different type of fuel without introducing errors. Also, when operated on a vehicle, pressure and temperature of the exhaust gas will vary. Using correction algorithms applied to the calibration developed on dry air at a constant pressure and temperature mitigated these sources of error. The flow meter placed on the exhaust system of the vehicle is calibrated using the portable flow calibration device using the exhaust of the vehicle and at varying pressures and temperatures as can be created by varying the engine speed during the calibration process. Because the flow calibrated of the flow meter is done against a portable flow calibration device while the flow meter to be calibrated is operated on the vehicle itself, the flow meter attached to the vehicle is de facto validated in its metrological performance for the vehicle about to be tested for mass emissions of regulated pollutants. The consequence is a potentially more accurate calibration of the flow meter attached to the exhaust system due to the factor that more of the real driving conditions and vehicle fuel/exhaust chemical composition type can be taken into consideration during the actual calibration process.

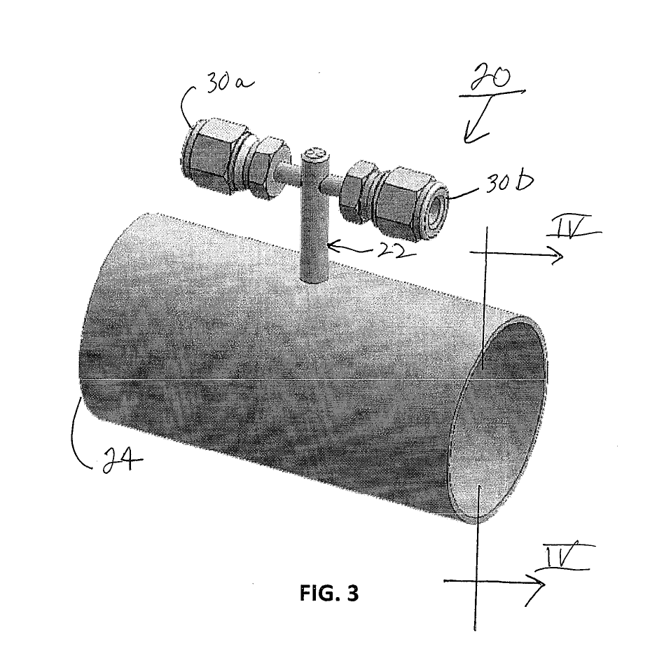

An averaging flow meter 20 includes a Pitot tube assembly 22 inserted in a flow tube 24. Pitot tube assembly 22 includes a Pitot sensing tube 26 that is made up of multiple holes 28 distributed along the length of tube 26. Sensing ports 30a, 30b are connected with a meter for differential pressure measurements as is conventional. The use of multiple holes 28 allows sufficient mitigation of the sources of flow measurement errors, such as wakes, eddies, circulating flows and flow pulsation, to provide exhaust flow measurement values that meet requirements for accuracy, repeatability, reproducibility and linearity without the need for a long flow tube to filter out such disturbances. As a result, flow tube 24 is significantly shorter than what is used in prior systems. In the illustrated embodiment, flow tube 24 is approximately 10 cm in length, but a greater or shorter length may be used. An upstream pressure monitoring port 32 is provided for pressure measurement upstream of averaging Pitot tube assembly 22 (FIG. 3).

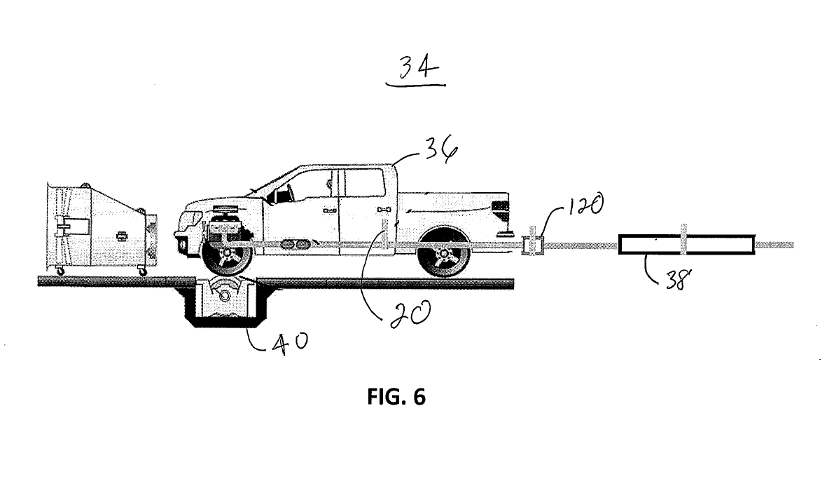

A test setup 34 for using a chassis dynamometer to produce exhaust flow measurements from a vehicle 36 under simulated driving conditions is shown in FIG. 6. A flow meter 20 is shown mounted to vehicle 36. Alternatively, an external flow sensing element 120 may be used so that it may be temporarily mounted to the vehicle and then removed. A portable reference flow meter 38 as previously described is applied to the vehicle. Vehicle 36 is placed on a chassis dynamometer 40 and the vehicle engine is allowed to operate at various speeds thus creating various chemical compositions of exhaust, emitting exhaust at various pressures, temperatures and flow during the driving cycle and, hence, providing vehicle-specific sources of variations in flow measurement. This yields a validated, vehicle-specific flow calibration that is more accurate for use with vehicle 36 than current testing methods. In order to calculate mass emissions, several data inputs are used. These include exhaust flow, real-time determination of the concentration of regulated pollutants on a molar basis. Other engine data inputs may be collected concurrently via a vehicle interface device.

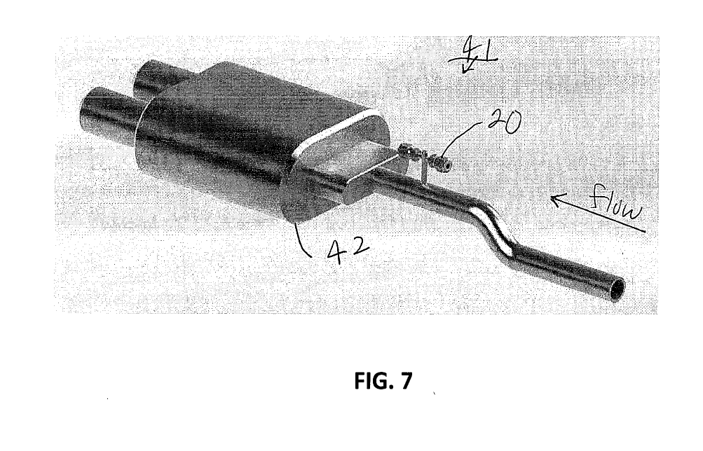

FIG. 7 illustrates a modified vehicle exhaust system 41 made up of flow meter 20 mounted directly in an exhaust system 42 of a vehicle. As can be seen, flow meter 20 can be integrally formed with the exhaust system in a permanent or semi-permanent manner without a significant addition of weight to the vehicle. Also, no separate flow tube of the type known in the prior art is required.

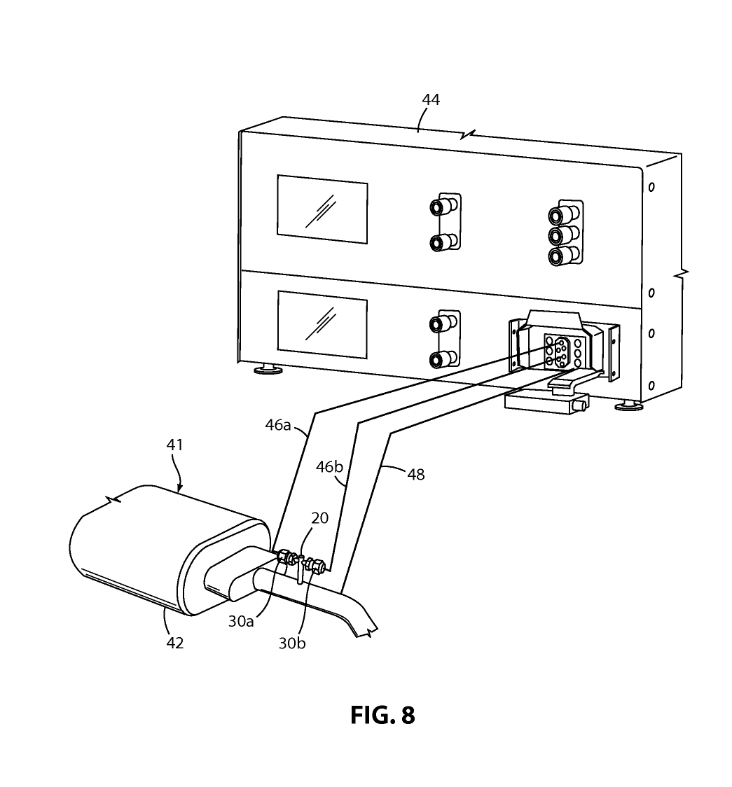

FIG. 8 illustrates connections between flow meter 20 and a PEMS 44 of the type marketed by Sensors, Inc. under the Semtech brand. PEMS 44 is capable of real-time measurement of the concentration of regulated pollutants on a molar basis. Pneumatic connections 46a, 46b are made with sensing ports 30a, 30b of flow meter 20. Pneumatic connections 46a, 46b provide high pressure air as input to Pitot tube assembly 22. Optional electrical connections may be provided if a heated gas sampling line 48 is used to carry an exhaust gas sample from a sampling point on the vehicle exhaust pipe to PEMS 44. A heated line prevents moisture condensation. Alternatively, an electrical connection may be used with a pressure transducer (not shown) that is connected with pressure monitoring port 32 of flow meter 20. The static wall pressure and gas temperature would also be measured. A data logger (not shown) may be integral with or connected with PEMS 44.

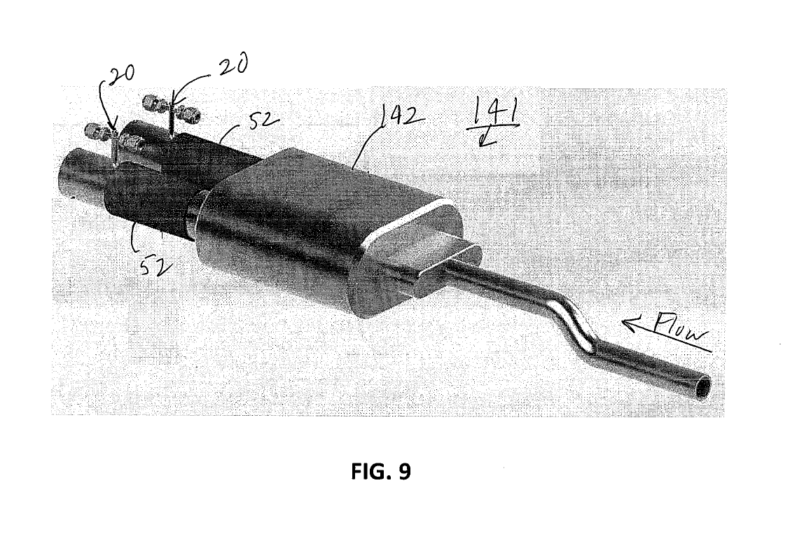

A modified vehicle exhaust system 141, including vehicle exhaust system 142, is shown in FIG. 9 with a pair of flow meters 20 mounted to outputs of the exhaust, such as with mounting hoses 52. Exhaust system 141 with flow meters 20 is useful for temporary installation of the flow meters, such as for infrequent testing of the vehicle. Also, it may be used for testing a large number of different vehicles over a short period of time. This is in contrast to exhaust system 42 in FIG. 7 that is useful for permanent or semi-permanent installation of the flow measuring device 20.

The use of a small flow meter at the tailpipe of the vehicle mitigates the following sources of error in in-use vehicle flow measurement for total mass emissions calculations under real driving conditions:
Aerodynamic concerns which are minimized by flow meter 20 extremely small form factor,
Added mass concerns which are minimized by flow meter 20 extremely small form factor, and
Installations difficulties and associated safety related concerns.

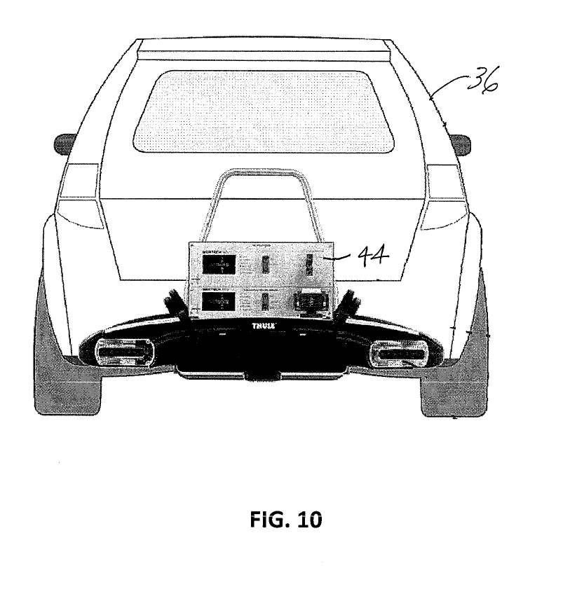

The use of a small averaging Pitot flow meter installed on a semi-permanent basis in the vehicle exhaust system greatly benefits vehicle manufacturers and long-term fleet emissions testing operators in terms of labor and operational savings as well by removing concern related to installations difficulties and associated potential safety issues and alleviating any mass or aerodynamic drag concern. Also, a complete analyzer solution including not only the reduced form factor flow meter, but also reduced form factor PEMs analyzer and ancillary accessories (GPS, weather station, etc.) as required for vehicle real driving emissions measurement and certification may be provided as an off-the-shelf car mounting accessory that can be easily mounted such as on a bicycle rack that is either fit to the tow-bar or strap to the rear of the vehicle without violating the designed maximum weights for these accessories (See FIG. 10).

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A calibration method for a flow measuring device used with a vehicle exhaust analysis system, said method comprising:
said flow measuring device being connected with the vehicle exhaust system wherein exhaust gases are directed through said flow measuring device;
connecting a portable flow calibration device wherein exhaust gases of the vehicle exhaust system are directed through the portable flow calibration device;
operating the vehicle wherein exhaust gas flows through said flow measuring device and said flow calibration device;
calibrating the flow measuring device with the portable flow calibration device.

2. A flow measuring device comprising:
a Pitot tube assembly in a flow tube wherein gas flowing through said flow tube passes said pitot tube assembly; and
said Pitot tube assembly comprising a sensing tube and at least one pressure sensing port connected with said sensing tube, said sensing tube comprising a plurality of sensing openings that are positioned at different portions of gas flowing through said flow tube.
